(19) United States
(12) Patent Application Publication
(10) Pub. No.: US 2025/0066540 A1
(43) Pub. Date: Feb. 27, 2025

(54) POLYESTER RESIN COMPOSITION AND HEAT-SHRINKABLE POLYESTER FILM

(71) Applicants: C.I. TAKIRON Corporation, Osaka (JP); Bonset America Corporation, Browns Summit, NC (US)

(72) Inventors: Takuma KANEKO, Osaka (JP); Yuichiro KANZAKA, Osaka (JP); Shuuta YUGE, Osaka (JP); Tatsuya IRIFUNE, Osaka (JP)

(21) Appl. No.: 18/725,799

(22) PCT Filed: Jun. 10, 2022
(86) PCT No.: PCT/JP2022/037474

§ 371 Date: Jun. 30, 2024

(30) Foreign Application Priority Data
Apr. 1, 2022 (JP) 2022-061626

(51) Int. Cl. C08G 63/183

(52) U.S. Cl. CPC C08G 63/183

(57) ABSTRACT

A polyester resin composition and a heat-shrinkable polyester film, which exhibit satisfactory recyclability, are provided.

Provided are a polyester resin composition including a recycled PET resin, and a heat-shrinkable polyester film derived from the polyester resin composition, which satisfy the following configurations (1) to (3):
(1) the polyester resin composition contains a recycled PET resin in an amount of 10% by weight or more with respect to the total amount; and
(2) and (3) when the polyester resin composition is produced into a film having a predetermined thickness, the haze value is less than 20%, and b* in the CIE chromaticity coordinates has a value within a range of 0.15 to 0.3.

### TECHNICAL FIELD

The present invention relates to a polyester resin composition and a heat-shrinkable polyester film (hereinafter, sometimes called as polyester-based shrink film or simply as a shrink film).

More particularly, the present invention relates to a polyester resin composition that provides excellent transparency and non-coloring property even when molded into a predetermined shape and recycled, and a heat-shrinkable polyester film derived from such a polyester resin composition.

### BACKGROUND ART

In recent years, the impact of plastic waste on the environment tends to raise a problem, and recycling of used plastic molded articles, simplification and volume reduction of plastic packaging materials, switching to materials having a smaller environmental load, and the like have been promoted or considered.

That is, so-called material recycling, in which used plastic molded articles are reused after being subjected to crushing, washing, and the like, is convenient and advantageous in terms of cost.

However, since not only thermoplastic resins that are main raw materials but also compounding agents, surface treatment agents that have been applied to molded articles, and the like are mixed in, there is observed a problem that recycled materials have inferior transparency compared to virgin resins and are easily colored, and particularly, since the degree of coloring increases when materials are repeatedly recycled, there is a problem that use applications are excessively limited.

Thus, a predetermined copolymerized polyester resin has been proposed for the purpose of solving the problems of recycling heat-shrinkable films derived from polyester resins containing dicarboxylic acids and diols as constituent components (see, for example, Patent Document 1).

That is, the predetermined copolymerized polyester resin is a copolymerized polyester resin in which a main component of dicarboxylic acid components is terephthalic acid, a main component of diol components is ethylene glycol, and when all the diol components are taken as 100 mol %, the content (amount of blended component) of diethylene glycol is in a range of 7 mol % to 30 mol %, while the content of triethylene glycol is in a range of 0.05 mol % to 2 mol %.

Furthermore, the predetermined copolymerized polyester resin is a copolymerized polyester resin in which the content of a cyclic dimer composed of terephthalic acid and diethylene glycol is 7000 ppm or less, while on the other hand, the content of a cyclic dimer composed of terephthalic acid, diethylene glycol, and triethylene glycol is 200 ppm or less.

### CITATION LIST

### Patent Document

Patent Document 1: WO 2021/210488 (claims and the like)

### DISCLOSURE OF THE INVENTION

### Problem to be Solved by the Invention

However, the copolymerized polyester resin with improved recyclability as disclosed in Patent Document 1 has a significantly large number of types of blending components, while the amounts of the blending components must be strictly observed, so that it is difficult to control non-crystallinity.

That is, it has been pointed out to the effect that when the blending amounts of diethylene glycol and triethylene glycol are less than the lower limits of predetermined ranges, the resulting copolymerized polyester resin becomes crystalline, resulting in poor transparency of a molded article or a film, and sufficient transparency cannot be attained, while the product value would be lost.

Thus, the inventors of the present invention made extensive efforts in view of the above-described problems, and as a result, the inventors solved the problems in the related art by providing a polyester resin composition containing a predetermined amount of a recycled PET resin, the polyester resin composition, which satisfies at least predetermined configurations (1) to (3).

That is, it is an object of the present invention to provide a heat-shrinkable polyester film that maintains transparency and non-coloring property even when the raw material contains a considerable amount of a recycled PET resin (PCR), and a polyester resin composition optimal for such a shrink film.

### Means for Solving Problem

According to the present invention, there is provided a polyester resin composition containing at least a recycled PET resin, the polyester resin composition satisfying the following configurations (1) to (3), and the above-mentioned problems can be solved.

(1) A blending amount of the recycled PET resin as a portion or the entirety of a crystalline polyester resin has a value of 10% by weight or more with respect to a total amount of the polyester resin composition.

(2) When the polyester resin composition is produced into a film having a predetermined thickness (for example, 30 μm), a haze value measured according to JIS K 7136:2000 is less than 20%.

(3) When the polyester resin composition is produced into a film having a predetermined thickness (for example, 30 μm), b* in chromaticity coordinates of CIE 1976 L*a*b* (hereinafter, may be simply referred to as CIE chromaticity coordinates) as measured according to JIS Z 8781-4:2013 has a value within a range of 0.15 to 0.3.

That is, by satisfying at least all of the configurations (1) to (3), even when the raw material contains a considerable amount of a recycled PET resin, which is a crystalline polyester resin, in a case where the polyester resin composition is molded into a predetermined shape and recycled, excellent transparency and non-coloring property (mainly yellowish color) can be obtained.

Specifically, a typical example of the film having a predetermined thickness (for example, 30 μm), for which the haze value or b* in the chromaticity coordinates is measured, is a shrink film described in Example 1 and the like that will be described below; however, the example is not limited thereto.

Therefore, on the premise of having a predetermined thickness, the film may be an original sheet before being subjected to a stretching treatment as a shrink film, or may be a non-shrinkable film for measurement intended for measuring the haze value, b* in the chromaticity coordinates, and the like.

Furthermore, upon configuring the polyester resin composition of the present invention, as configuration (4), when a recycled PET resin is not blended, and the polyester resin composition is produced into a film having a predetermined thickness, in a case where b* in the chromaticity coordinates of CIE 1976 L*a*b* as measured according to JIS Z 8781-4:2013 is designated as b*₀, it is preferable that a numerical value represented by b*-b*₀ has a value of 0.01 or more.

By limiting the numerical value represented by b*-b*₀ in the CIE chromaticity coordinates in this way, a polyester resin that provides excellent transparency and non-coloring property (mainly yellowish color) when the polyester resin is molded into a predetermined shape and repeatedly recycled, can be obtained.

Furthermore, upon configuring the polyester resin composition of the present invention, as configuration (5), when the polyester resin composition is produced into a film having a predetermined thickness, it is preferable that a* in the chromaticity coordinates of CIE 1976 L*a*b* as measured according to JIS Z 8781-4:2013 has a value within a range of −0.15 to −0.05.

By limiting a* in the CIE chromaticity coordinates in this way, a polyester resin that is more likely to maintain transparency and non-coloring property (mainly greenish color) even when repeatedly recycled, in a case where the material is molded into a predetermined shape and repeatedly recycled, can be obtained.

Furthermore, upon configuring the polyester resin composition of the present invention, as configuration (6), when the polyester resin composition is produced into a film having a predetermined thickness, it is preferable that L* in the chromaticity coordinates of CIE 1976 L*a*b* as measured according to JIS Z 8781-4:2013 has a value of 90 or more.

By limiting L* in this way, which is an index of whiteness in the CIE chromaticity coordinates, a polyester resin that is more likely to maintain transparency and non-coloring property (mainly yellowish or greenish color) even when repeatedly recycled, in a case where the material is molded into a predetermined shape and repeatedly recycled, can be obtained.

Furthermore, upon configuring the polyester resin composition of the present invention, as configuration (7), it is preferable that the polyester resin composition includes a non-crystalline polyester resin, and a blending amount of the non-crystalline polyester resin has a value within a range of 50% to 90% by weight with respect to the total amount of the polyester resin composition.

By configuring the polyester resin composition in this way, when a heat-shrinkable polyester film is formed, the thermal shrinkage ratio in the TD direction, which is a main shrinkage direction, or the thermal shrinkage ratio in the MD direction that orthogonally intersects the TD direction, which are obtained in a case where the heat-shrinkable polyester film is shrunk under the conditions of, for example, 10 seconds in hot water at 70° C. to 98° C., can be accurately controlled.

Another embodiment of the present invention is a heat-shrinkable polyester film derived from any of the above-mentioned polyester resin compositions, in which when a main shrinkage direction of the heat-shrinkable polyester film is designated as TD direction, and a thermal shrinkage ratio obtained in a case where the heat-shrinkable polyester film is shrunk in the TD direction under the conditions of 10 seconds in hot water at 80° C. is designated as A1, the A1 has a value of 20% or more.

By configuring in this way, as a heat-shrinkable polyester film obtained by blending a considerable amount of a recycled PET resin, the heat-shrinkable polyester film can exhibit basic thermal shrinkability (in hot water at 80° C. for 10 seconds) while maintaining transparency and non-coloring property.

Furthermore, upon configuring the heat-shrinkable polyester film of the present invention, when a thermal shrinkage ratio obtained in a case where the heat-shrinkable polyester film is shrunk in the TD direction under the conditions of 10 seconds in hot water at 98° C. is designated as A2, it is preferable that the A2 has a value of 35% or more.

By configuring in this way, as a heat-shrinkable polyester film obtained by blending a considerable amount of a recycled PET resin, the heat-shrinkable polyester film can basically exhibit thermal shrinkability in a high temperature range.

Furthermore, upon configuring the heat-shrinkable polyester film of the present invention, when a thermal shrinkage ratio obtained in a case where the heat-shrinkable polyester film is shrunk in the TD direction under the conditions of 10 seconds in hot water at 70° C. is designated as A3, it is preferable that the A3 has a value of 5% or more.

By configuring in this way, as a heat-shrinkable polyester film in which a recycled PET resin is utilized, the heat-shrinkable polyester film can exhibit predetermined thermal shrinkability even in a low temperature range.

### BRIEF DESCRIPTION OF DRAWINGS

FIG. 1 is a diagram for describing the relationship between the blending amount of a PCR and the value of b* in the CIE chromaticity coordinates;

FIG. 2 is a diagram for describing the relationship between the blending amount of a PCR and the haze value in the heat-shrinkable polyester film;

FIG. 3 is a diagram for describing the relationship between the blending amount of a PCR and a numerical value represented by b*-b*₀ in the CIE chromaticity coordinates;

FIG. 4 is a diagram for describing the relationship between the blending amount of a PCR and the value of a* in the CIE chromaticity coordinates;

FIG. 5 is a diagram for describing the relationship between the blending amount of a PCR and the value of L* in the CIE chromaticity coordinates;

FIGS. 6A to 6C are each a diagram for describing a form of the heat-shrinkable polyester film;

FIGS. 7A and 7B are diagrams for describing the relationship between the blending amount of a PCR and a thermal shrinkage ratio (A1) in a case where the heat-shrinkable polyester film is shrunk in the TD direction under the conditions of 10 seconds in hot water at 80° C., and the relationship between the blending amount of a PCR and a thermal shrinkage ratio (A2) in a case where the heat-shrinkable polyester film is shrunk under the conditions of 10 seconds in hot water at 98° C., respectively; and

FIG. 8 is a diagram for describing the relationship between the blending amount of a PCR and a thermal shrinkage ratio (A3) in a case where the heat-shrinkable polyester film is shrunk in the TD direction under the conditions of 10 seconds in hot water at 70° C.

### BEST MODES FOR CARRYING OUT THE INVENTION

### First Embodiment

A first embodiment is a polyester resin composition containing at least a recycled PET resin, the polyester resin composition satisfying the following configurations (1) to (3):
(1) a blending amount of the recycled PET resin as a portion or the entirety of a crystalline polyester resin has a value of 10% by weight or more with respect to a total amount of the polyester resin composition;
(2) when the polyester resin composition is produced into a film having a predetermined thickness (30 μm), a haze value measured according to JIS K 7136:2000 is less than 20%; and
(3) when the polyester resin composition is produced into a film having a predetermined thickness (30 μm), b* in chromaticity coordinates of CIE 1976 L*a*b* as measured according to JIS Z 8781-4:2013 has a value within a range of 0.15 to 0.3.

Hereinafter, the polyester resin composition of the first embodiment will be specifically described with appropriate reference to the drawings.

### 1. Main Component

Regarding a polyester resin, which is a main component, the type thereof is basically not limited as long as it is a polyester resin that is likely to satisfy the above-mentioned configurations of (1) to (3); however, usually, it is preferable that the polyester resin is a polyester resin composed of a diol and a dicarboxylic acid, a polyester resin composed of a diol and a hydroxycarboxylic acid, a polyester resin composed of a diol, a dicarboxylic acid, and a hydroxycarboxylic acid, or a mixture of these polyester resins.

Here, the diol as a raw material component of the polyester resin may be at least one of aliphatic diols such as ethylene glycol, diethylene glycol, propanediol, butanediol, neopentyl glycol, and hexanediol; alicyclic diols such as 1, 4-hexanedimethanol; and aromatic diols.

Among these, ethylene glycol, diethylene glycol, and 1, 4-hexanedimethanol are particularly preferred.

The dicarboxylic acid as a compound component of the same polyester resin may be at least one of fatty acid dicarboxylic acids such as adipic acid, sebacic acid, and azelaic acid; aromatic dicarboxylic acids such as terephthalic acid, naphthalenedicarboxylic acid, and isophthalic acid; alicyclic dicarboxylic acids such as 1,4-cyclohexanedicarboxylic acid; or ester-forming derivatives of these.

Among these, terephthalic acid is particularly preferred.

The hydroxycarboxylic acid as a compound component of the same polyester resin may be at least one of lactic acid, hydroxybutyric acid, and polycaprolactone.

As a non-crystalline polyester resin, for example, a non-crystalline polyester resin composed of dicarboxylic acids including at least 80 mol % of terephthalic acid, and diols composed of 50 mol % to 80 mol % of ethylene glycol and 20 mol % to 50 mol % of one or more selected from 1,4-cyclohexanedimethanol, neopentyl glycol, and diethylene glycol, can be suitably used.

In order to change the property of the film as needed, other dicarboxylic acids and diols or hydroxycarboxylic acids may also be used. Each of these components may be used singly or as a mixture.

On the other hand, examples of the crystalline polyester resin include polyethylene terephthalate, polyethylene naphthalate, polybutylene terephthalate, polybutylene naphthalate, and polypropylene terephthalate, and each of these may be used singly or as a mixture.

Furthermore, when the polyester resin is a mixture of a crystalline polyester resin and a non-crystalline polyester resin, in order to obtain satisfactory and appropriate recyclability, heat resistance, thermal shrinkage ratio, and the like, it is preferable that the blending amount of the crystalline polyester resin has a value within a range of 10% to 50% by weight with respect to the total amount (100% by weight) of the resins constituting the heat-shrinkable polyester film.

The reason for this is that by adjusting the blending amount of the crystalline polyester resin to a value within a predetermined range, a heat-shrinkable polyester film that exhibits satisfactory thermal shrinkage characteristics and has little change in the thermal shrinkage ratio at a predetermined temperature as a physical property even under high humidity conditions, can be obtained.

Therefore, it is more preferable that the blending amount of the crystalline polyester resin has a value within a range of 15% to 45% by weight, and even more preferably a value within a range of 20% to 40% by weight, with respect to the total amount (100% by weight) of resins.

Conversely, upon configuring the polyester resin composition, as configuration (7), it is preferable that the polyester resin composition includes a non-crystalline polyester resin, and at the same time, the blending amount of the non-crystalline polyester resin has a value within a range of 50% to 90% by weight, more preferably a value within a range of 55% to 85% by weight, and even more preferably a value within a range of 60% to 80% by weight, with respect to the total amount of the polyester resin composition.

### 2. Recycled PET Resin

A typical example of the recycled PET resin is a PCR resin (hereinafter, may be simply referred to as PCR), which is an abbreviation of a post-consumer recycled resin.

Such a PCR generally uses industrial waste plastics as a main material and is a raw material derived from PET bottles and the like to be recycled, and a PCR is defined as a recycled polyester resin as a crystalline polyester resin (hereinafter, may be referred to as a recycled crystalline polyester resin) in the form of “product having a shape of powder, granules, flakes, pellets, or fluff”, which includes a single polyester material or a plurality of polyester materials and has been recycled.

That is, by using a PCR as the entirety or a portion of the recycled PET resin, a shrink film maintaining transparency and non-coloring property is formed efficiently and economically, as a result, recycling of PET bottles and the like is promoted, and furthermore, the environmental load can be remarkably reduced.

Furthermore, the average molecular weight (Mn) of such a PCR is usually 5000 to 50000, and the PCR can also include resins having molecular weights increased to about 2 to 3 times by blending HDPE, HDPP, and the like.

That is, by using a PCR having a controlled average molecular weight as the entirety or a portion of the recycled PET resin, a shrink film maintaining transparency and non-coloring property can be formed more efficiently and economically.

Moreover, with regard to the CIE chromaticity coordinates for such a recycled PET resin, a* is usually within a range of −2 to 0.

Similarly, b* in the CIE chromaticity coordinates for a recycled PET resin is usually within a range of 2.5 to 5.

Also similarly, L* for a recycled PET resin is usually within a range of 50 to 65.

Therefore, when a PCR is used as the recycled PET resin, it is preferable to appropriately select the type of the PCR by taking each of the values of at and L* in the CIE chromaticity coordinates of the PCR itself into consideration.

For example, upon controlling b* in the CIE chromaticity coordinates of a shrink film derived from the polyester resin composition to a value within a predetermined range (0.15 to 0.3), it is preferable that b* in the CIE chromaticity coordinates for the PCR has a value of 4.7 or less, more preferably a value of 4.5 or less, and even more preferably a value of 4.3 or less.

### 3. Configuration (1)

Configuration (1) is an essential configuration requirement to the effect that the blending amount of a recycled PET resin as a portion or the entirety of a crystalline polyester resin has a value of 10% by weight or more with respect to the total amount of the polyester resin composition.

That is, even when the raw material contains a predetermined amount or more of a recycled PET resin, which is a crystalline polyester resin, transparency and non-coloring property can be maintained, and a polyester resin composition appropriate for recycling can be obtained.

When a recycled PET resin is used as a portion of a crystalline polyester resin, it is preferable to use the recycled PET resin in an amount in a range of 10% by weight or more, more preferably in a range of 20% to 90% by weight, and even more preferably in a range of 50% to 80% by weight, with respect to the total amount of the crystalline polyester resin.

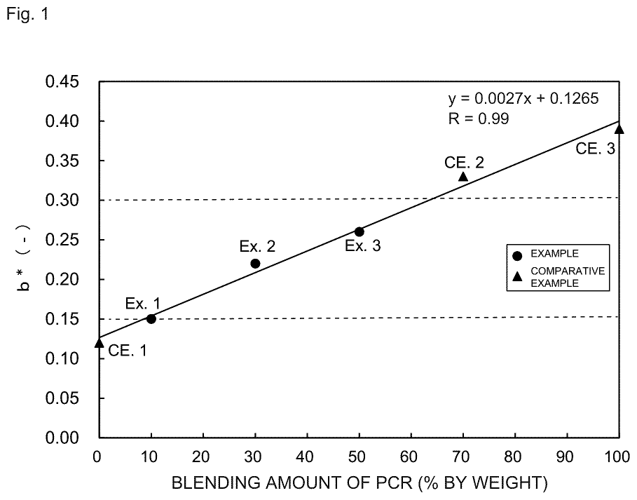

Here, referring to FIG. 1, in regard to a case where the polyester resin composition is produced into a film having a predetermined thickness (for example, 30 μm) according to Example 1 and the like, the relationship between the blending amount of the PCR and b* in the chromaticity coordinates of CIE 1976 L*a*b* (hereinafter, may be simply referred to as CIE chromaticity coordinates) measured according to JIS Z 8781-4:2013, will be described.

That is, the axis of abscissa in FIG. 1 represents the blending amount (% by weight) of the PCR, and the axis of ordinate represents the value of b* (−) in the CIE chromaticity coordinates.

Furthermore, in the diagram, Example 1 is described as Ex. 1, while Comparative Example 1 is described as CE. 1, and the same applies hereinafter.

From the characteristic curve in FIG. 1, it is understood that under certain conditions, there is an excellent correlation (correlation coefficient (R) is 0.99) in the relationship between the blending amount of the PCR and the value of b* in the chromaticity coordinates.

Therefore, it can be said that by limiting the blending amount of the PCR, the value of b* in the chromaticity coordinates is easily controlled to be within a predetermined range.

Conversely, it can be said that by limiting b* in the chromaticity coordinates to a value within a predetermined range (0.15 to 0.3) under certain conditions, the blending amount of the PCR can be controlled more accurately, though indirectly.

### 4. Configuration (2)

Configuration (2) is an essential configuration requirement to the effect that when the polyester resin composition is produced into a film having a predetermined thickness (for example, 30 μm), a haze value measured according to JIS K 7136:2000 is less than 20%.

That is, when a polyester resin composition containing a predetermined amount of a recycled PET resin is produced into a heat-shrinkable polyester film or the like having a predetermined thickness according to Example 1 and the like that will be described below, the heat-shrinkable polyester film and the like can maintain versatility in various use applications even when recycled, by making the haze value relatively small.

However, when such a haze value is excessively small, the types of the polyester resin available for use or the product yield may be markedly decreased.

Therefore, although it is an essential configuration requirement to adjust the haze value measured according to JIS K 7136:2000 to be less than 20%, more preferably, it is more preferable that the haze value has a value within a range of 1.5% to 10%, and even more preferably a value within a range of 1.6% to 5%.

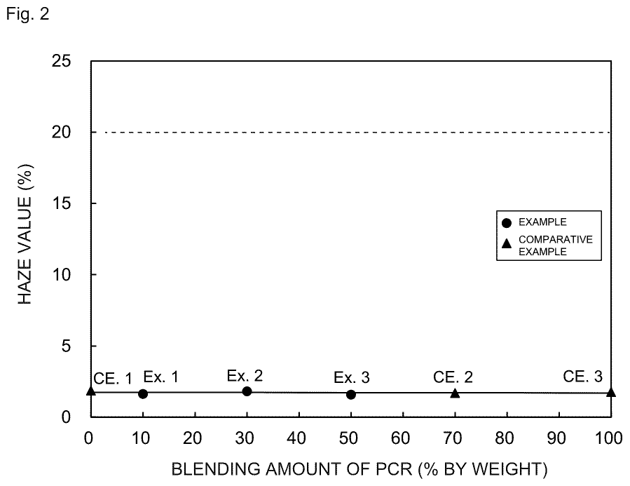

Here, referring to FIG. 2, in regard to a case where the polyester resin composition is produced into a film having a predetermined thickness (for example, 30 μm) according to Example 1 and the like, the relationship between the blending amount of the PCR and the haze value measured according to JIS K 7136:2000 will be described.

That is, the axis of abscissa in FIG. 2 represents the blending amount (% by weight) of the PCR, and the axis of ordinate represents the haze value (%).

From the characteristic curve in FIG. 2, it is understood that in the relationship between the blending amount (% by weight) of the PCR and the haze value (%) under certain conditions, an almost constant haze value is obtained regardless of the blending amount of the PCR.

### 5. Configuration (3)

Configuration (3) is an essential configuration requirement to the effect that when the polyester resin composition is produced into a film having a predetermined thickness (for example, 30 μm), b* in the chromaticity coordinates of CIE 1976 L*a*b* as measured according to JIS Z 8781-4:2013 has a value within a range of 0.15 to 0.3.

That is, in a case where a polyester resin composition containing a predetermined amount of a recycled PET resin is produced into a predetermined heat-shrinkable polyester film or the like according to Example 1 and the like that will be described below, a polyester resin that maintains transparency and non-coloring property on yellowish color more accurately even when repeatedly recycled, can be obtained by adjusting b* in the chromaticity coordinates to a value within a predetermined range.

Therefore, it is more preferable that b* has a value within a range of 0.17 to 0.28, and even more preferably a value within a range of 0.19 to 0.26.

As described above, it has been made clear from the characteristic curve in FIG. 1 that there is an excellent correlation (correlation coefficient (R) is 0.99) in the relationship between the blending amount of the PCR and the value of b* in the chromaticity coordinates.

### 6. Configuration (4)

Configuration (4) is an optional configuration requirement to the effect that a predetermined amount of a recycled PET resin is not blended, and as a film having a predetermined thickness (for example, 30 μm), when b* in the chromaticity coordinates of CIE 1976 L*a*b* as measured according to JIS Z 8781-4:2013 is designated as b*₀, a numerical value represented by b*-b*₀ has a value of 0.01 or more.

That is, in a case where a predetermined heat-shrinkable polyester film or the like is produced according to Example 1 and the like that will be described below, a polyester resin that maintains transparency and non-coloring property more accurately even when repeatedly recycled can be obtained by controlling the numerical value represented by b*-b*₀ in the CIE chromaticity coordinates to a predetermined range in this way.

However, when such a numerical value represented by b*-b*₀ is excessively large, it may be difficult to obtain a polyester resin that maintains transparency and non-coloring property accurately by repeatedly recycling the polyester resin.

Therefore, it is more preferable that the numerical value represented by b*-b*₀ has a value within a range of 0.03 to 0.2, and even more preferably a value within a range of 0.1 to 0.18.

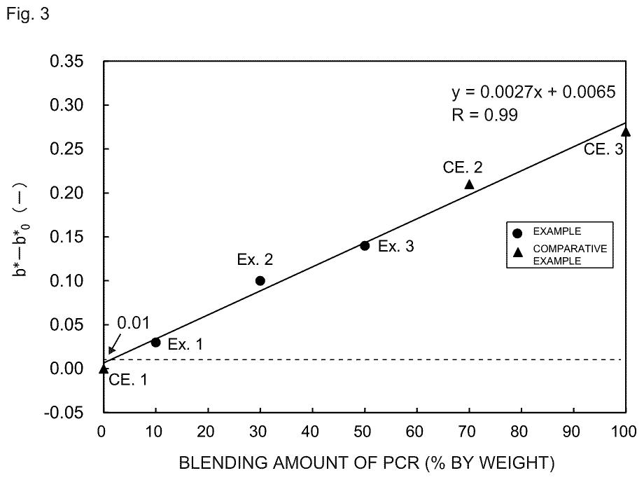

Here, referring to FIG. 3, the relationship between the blending amount of the PCR and the numerical value represented by b*-b*₀ in the CIE chromaticity coordinates will be described.

That is, the axis of abscissa in FIG. 3 represents the blending amount (% by weight) of the PCR, and the axis of ordinate represents the numerical value (−) represented by b*-b*₀ in the CIE chromaticity coordinates obtained when the polyester resin composition is produced into a predetermined heat-shrinkable polyester film.

From the characteristic curve in FIG. 3, it is understood that under certain conditions, there is an excellent correlation (correlation coefficient (R) is 0.99) in the relationship between the blending amount of the PCR and the numerical value represented by b*-b*₀ in the CIE chromaticity coordinates.

Therefore, it can be said that by limiting the blending amount of the PCR, the numerical value represented by b*-b*₀ in the CIE chromaticity coordinates can be controlled extremely accurately to a predetermined range (0.01 or more).

Conversely, it can be said that by limiting the numerical value represented by b*-b*₀ in the CIE chromaticity coordinates to a predetermined range (0.01 or more), the blending amount of the PCR can be controlled more accurately, though indirectly.

### 7. Configuration (5)

Configuration (5) is an optional configuration requirement to the effect that when the polyester resin composition is produced into a film having a predetermined thickness (for example, 30 μm), a* in the chromaticity coordinates of CIE 1976 L*a*b* as measured according to JIS Z 8781-4:2013 has a value within a range of −0.15 to −0.05. That is, by limiting a* in the CIE chromaticity coordinates in a case where the polyester resin composition is produced into a predetermined heat-shrinkable polyester film or the like according to Example 1 and the like that will be described below, a polyester resin that maintains transparency and non-coloring property on greenish tinge even when repeatedly recycled can be obtained.

Therefore, it is more preferable that a* in the CIE chromaticity coordinates has a value within a range of −0.14 to −0.06, and even more preferably a value within a range of −0.13 to −0.07.

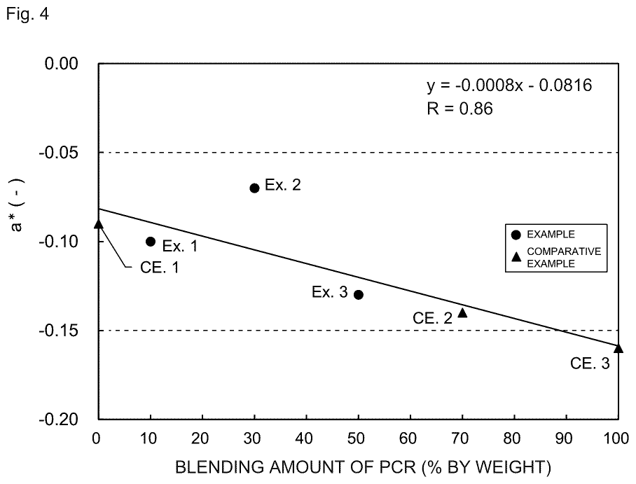

Here, referring to FIG. 4, the relationship between the blending amount of the PCR, which is a recycled PET resin, and a* in the CIE chromaticity coordinates will be described.

That is, the axis of abscissa in FIG. 4 represents the blending amount (% by weight) of the PCR, and the axis of ordinate represents a* in the CIE chromaticity coordinates in a case where the polyester resin composition is produced into a predetermined heat-shrinkable polyester film.

From the characteristic curve in FIG. 4, it is understood that under certain conditions, there is a satisfactory correlation (correlation coefficient (R) is 0.86) in the relationship between the blending amount of the PCR and at in the CIE chromaticity coordinates.

Therefore, it can be said that by limiting the blending amount of the PCR, at in the CIE chromaticity coordinates is easily controlled to be within a predetermined range.

Conversely, it can be said that by limiting the numerical value represented by a* in the CIE chromaticity coordinates to a value within a predetermined range under certain conditions, the blending amount of the PCR can be controlled more accurately, though indirectly.

### 8. Configuration (6)

Configuration (6) is an optional configuration requirement to the effect that when the polyester resin composition is produced into a film having a predetermined thickness (30 μm), L* in the chromaticity coordinates of CIE 1976 L*a*b* as measured according to JIS Z 8781-4:2013 has a value of 90 or more.

That is, by limiting L* in the CIE chromaticity coordinates in a case where the polyester resin composition is produced into a predetermined heat-shrinkable polyester film according to Example 1 and the like that will be described below, a polyester resin that maintains transparency and non-coloring property in considering of whiteness even when repeatedly recycled can be obtained.

Therefore, it is more preferable that L* in the CIE chromaticity coordinates has a value within a range of 92 to 99, and even more preferably a value within a range of 93 to 98.

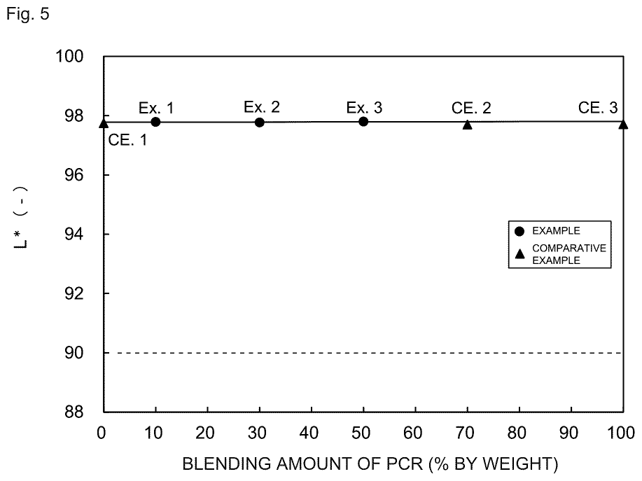

Here, referring to FIG. 5, the relationship between the blending amount of the PCR, which is a recycled PET resin, and L* in the CIE chromaticity coordinates will be described.

That is, the axis of abscissa in FIG. 5 represents the blending amount (% by weight) of the PCR, and the axis of ordinate represents L* in the CIE chromaticity coordinates in a case where the polyester resin composition is produced into a predetermined heat-shrinkable polyester film.

From the characteristic curve in FIG. 5, it is understood that with regard to the relationship between the blending amount of the PCR and L* in the CIE chromaticity coordinates under certain conditions, an almost constant L* is obtained regardless of the blending amount of the PCR.

### Second Embodiment

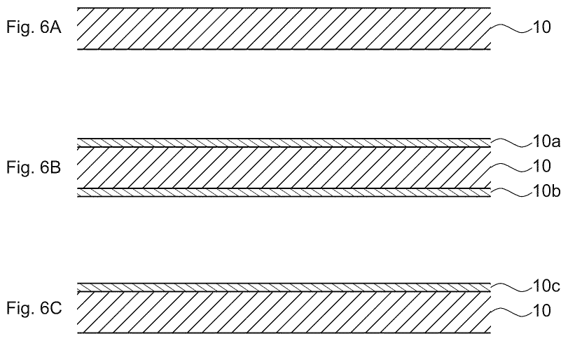

A second embodiment is, as illustrated in FIGS. 6A to 6C, a heat-shrinkable polyester film 10 derived from the polyester resin composition of the first embodiment, in which when a main shrinkage direction of the heat-shrinkable polyester film is designated as TD direction, a thermal shrinkage ratio obtained in a case where the heat-shrinkable polyester film is shrunk in the TD direction under the conditions of 10 seconds in hot water at 80° C. has a value of 20% or more.

Hereinafter, the heat-shrinkable polyester film of the second embodiment will be specifically described with appropriate reference to the drawings.

### 1. Polyester Resin Composition

Since the polyester resin composition of the first embodiment that has been already described can be used as the polyester resin composition, further description will not be repeated.

### 2. Heat-Shrinkable Polyester Film

### (1) Thickness

It is a configuration requirement related to the thickness (average thickness) before thermal shrinkage of the heat-shrinkable polyester film of the first embodiment and is an optional configuration requirement to the effect that the thickness has a value usually within a range of 15 to 70μ m.

That is, by specifically limiting the thickness before thermal shrinkage of the heat-shrinkable polyester film to a value within a predetermined range in this way, each of thermal shrinkage ratios A1, A2, and A3, the haze value, and the like is likely to be controlled more easily to a value within a predetermined range.

Therefore, non-uniform shrinkage caused by rapid thermal response in the heat-shrinkable polyester film at the time of thermal shrinkage can be suppressed by reducing the influence of predetermined factors, and as a result, recyclability can also be controlled.

More specifically, it is because when the thickness before thermal shrinkage of the heat-shrinkable polyester film is less than 15 μm or more than 70 μm, non-uniform shrinkage caused by rapid thermal response in the heat-shrinkable polyester film at the time of thermal shrinkage cannot be suppressed, and the heat-shrinkable polyester film may be colored, or transparency and the like may be decreased.

Therefore, as configuration (e), it is more preferable that the thickness before thermal shrinkage of the heat-shrinkable polyester film has a value within a range of 20 to 50 μm, and even more preferably a value within a range of 25 to 40 μm.

### (2) CIE Chromaticity Coordinates

Regarding each of b*, the numerical value represented by b*-b*₀, and a* in the CIE chromaticity coordinates for the polyester resin composition (measured as a shrink film having a predetermined thickness), a satisfactory correlation with the blending amount of the PCR is obtained as shown in FIG. 1 and the like.

Furthermore, also with regard to L* in the CIE chromaticity coordinates, an almost constant value can be obtained under constant conditions regardless of the blending amount of the PCR, as shown in FIG. 5 and the like.

Therefore, also with regard to b*, the numerical value represented by b*-b*₀, a*, and L* in the CIE chromaticity coordinates for the heat-shrinkable polyester film, since the contents are substantially similar to the contents for the polyester resin composition of the first embodiment as previously described, further description will not be repeated.

### (3) Haze Value

With regard to the haze value of the polyester resin composition (measured as a shrink film having a predetermined thickness), an almost constant haze value can be obtained under certain conditions regardless of the blending amount of the PCR, as shown in FIG. 2 and the like.

Therefore, also with regard to the haze value of the heat-shrinkable polyester film, since the contents are substantially similar to the contents for the polyester resin composition of the first embodiment as previously described, further description will not be repeated.

### (4) Thermal Shrinkage Ratio 1

As a thermal shrinkage ratio 1, when a main shrinkage direction of the heat-shrinkable polyester film is designated as TD direction, and a thermal shrinkage ratio obtained in a case where the heat-shrinkable polyester film is shrunk in the TD direction under the conditions of 10 seconds in hot water at 80° C. is designated as A1, it is preferable that the A1 has a value of 20% or more.

The reason for this is that by specifically limiting such a thermal shrinkage ratio A1 to be equal to or more than a predetermined value, the heat-shrinkable polyester film can maintain the basic thermal shrinkability in the TD direction (in hot water at 80° C. for 10 seconds), which is exhibited in various use applications as a heat-shrinkable polyester film utilizing a recycled PET resin.

More specifically, when the thermal shrinkage ratio A1 has a value of less than 20%, thermal shrinkability may be decreased, and the heat-shrinkable polyester film may not be applied to various use applications.

Therefore, it is more preferable that the thermal shrinkage ratio A1 has a value within a range of 25% to 55%, and even more preferably a value within a range of 30% to 50%.

The thermal shrinkage ratios (A1 to A3, and the like) for a heat-shrinkable polyester film are defined by the following formula.

$$Thermal shrinkage ratio ( \% ) = ( {L}_{0} - {L}_{1} ) / {L}_{0} \times 100$$

L₀: Dimension (longitudinal direction or width direction) of a sample before being subjected to heat treatment at a predetermined temperature for a predetermined time

L₁: Dimension (same direction as L₀) of the sample after being subjected to heat treatment at a predetermined temperature for a predetermined time

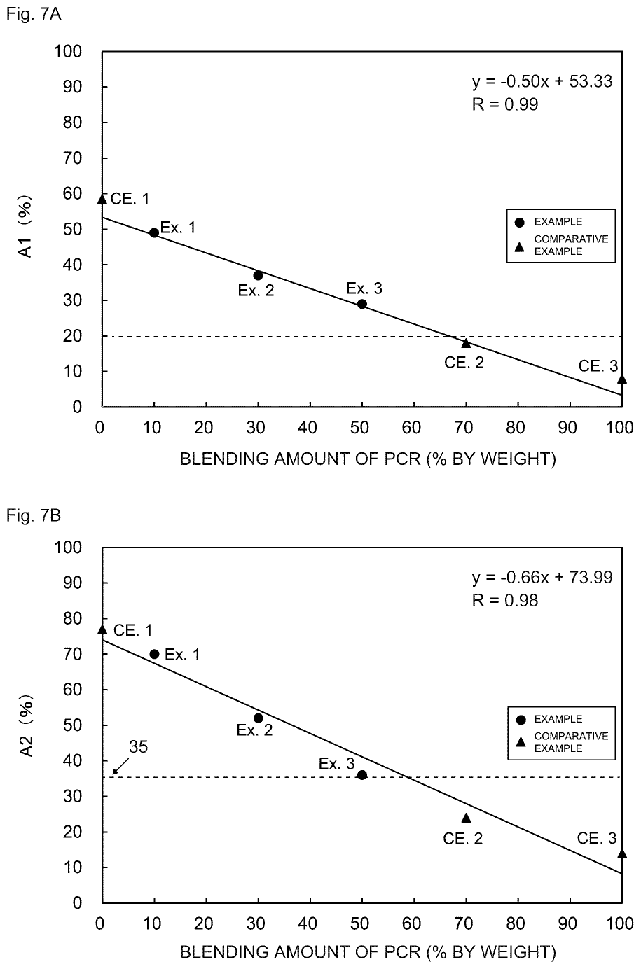

Here, referring to FIGS. 7A and 7B, the relationship between the blending amount of the PCR as a recycled PET resin and the thermal shrinkage ratio (A1) obtained in a case where the heat-shrinkable polyester film is shrunk in the TD direction under the conditions of 10 seconds in hot water at 80° C., and the relationship between the blending amount of the PCR and the thermal shrinkage ratio (A2) obtained in a case where the heat-shrinkable polyester film is shrunk under the conditions of 10 seconds in hot water at 98° C. will be described.

That is, the axis of abscissa in FIGS. 7A and 7B represents the blending amount (% by weight) of the PCR, and the axis of ordinate represents A1(%), which is the thermal shrinkage ratio obtained in a case where the heat-shrinkable polyester film is shrunk in the TD direction under the conditions of 10 seconds in hot water at 80° C., and A2(%), which is the thermal shrinkage ratio obtained in a case where the heat-shrinkable polyester film is shrunk under the conditions of 10 seconds in hot water at 98° C.

From the characteristic curves in FIGS. 7A and 7B, it is understood that there is a satisfactory correlation (correlation coefficients (R) are 0.99 and 0.98, respectively) in each of the relationship between the blending amount of the PCR and the thermal shrinkage ratio A1 and the relationship between the blending amount of the PCR and the thermal shrinkage ratio A2, under certain conditions.

Therefore, it can be said that by limiting the blending amount of the PCR under certain conditions, each of the thermal shrinkage ratio A1 and the thermal shrinkage ratio A2 is easily controlled to be in a predetermined range.

### (5) Thermal Shrinkage Ratio 2

As a thermal shrinkage ratio 2, when a main shrinkage direction of the heat-shrinkable polyester film is designated as TD direction, and a thermal shrinkage ratio obtained in a case where the heat-shrinkable polyester film is shrunk in the TD direction under the conditions of 10 seconds in hot water at 98° C. is designated as A2, it is preferable that the A2 has a value of 30% or more.

The reason for this is that by limiting such a thermal shrinkage ratio A2 to be equal to or more than a predetermined value, the heat-shrinkable polyester film can maintain the basic thermal shrinkability in the TD direction (in hot water at 98° C. for 10 seconds), which is exhibited in various use applications as a heat-shrinkable polyester film utilizing a recycled PET resin.

More specifically, it is because when the thermal shrinkage ratio A2 has a value of less than 30%, thermal shrinkability may be decreased, and the use applications available for use may be excessively limited.

Therefore, it is more preferable that the thermal shrinkage ratio A2 has a value within a range of 35% to 75%, and even more preferably a value within a range of 40% to 70%.

### (6) Thermal Shrinkage Ratio 3

As a thermal shrinkage ratio 3, when a main shrinkage direction of the heat-shrinkable polyester film is designated as TD direction, and a thermal shrinkage ratio obtained in a case where the heat-shrinkable polyester film is shrunk in the TD direction under the conditions of 10 seconds in hot water at 70° C. is designated as A3, it is preferable that the A3 has a value of 5% or more.

The reason for this is that by limiting such a thermal shrinkage ratio A3 to be equal to or more than a predetermined value, the heat-shrinkable polyester film can maintain the basic thermal shrinkability in the TD direction (in hot water at 70° C. for 10 seconds), which is exhibited in various use applications as a heat-shrinkable polyester film utilizing a recycled PET resin.

More specifically, when the thermal shrinkage ratio A3 has a value of less than 5%, thermal shrinkability may be decreased, and the use applications available for use may be excessively limited.

Therefore, it is more preferable that the thermal shrinkage ratio A3 has a value within a range of 6% to 18%, and even more preferably a value within a range of 7% to 16%.

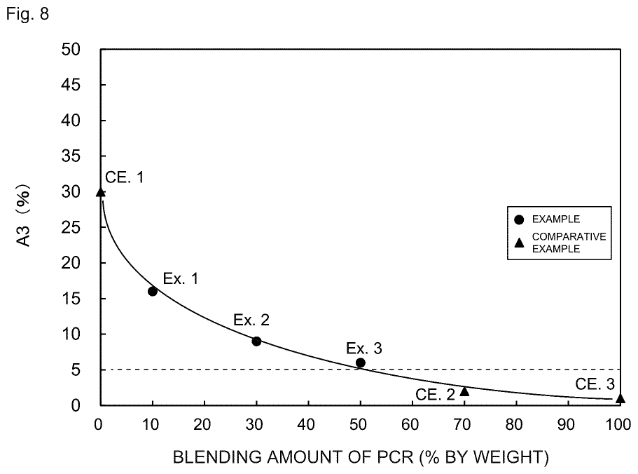

Here, referring to FIG. 8, the relationship between the blending amount of the PCR as a recycled PET resin and the thermal shrinkage ratio (A3) obtained in a case where the heat-shrinkable polyester film is shrunk in the TD direction under the conditions of 10 seconds in hot water at 70° C., will be described.

That is, the axis of abscissa in FIG. 8 represents the blending amount (% by weight) of the PCR, and the axis of ordinate represents A3(%), which is the thermal shrinkage ratio obtained in a case where the heat-shrinkable polyester film is shrunk in the TD direction under the conditions of 10 seconds in hot water at 70° C.

From the characteristic curve in FIG. 8, it is understood that there is a satisfactory correlation in the relationship between the blending amount of the PCR and the thermal shrinkage ratio A3 under certain conditions.

Therefore, it can be said that by limiting the blending amount of the PCR under certain conditions, the thermal shrinkage ratio A3 is also easily controlled to be within a predetermined range.

### (7) Others 1

The heat-shrinkable polyester film of the second embodiment may be a single layer as shown in FIG. 6A, or it is preferable that various additives are blended into or attached to one surface or both surfaces of the heat-shrinkable polyester film.

More specifically, it is preferable that at least one of a hydrolysis inhibitor, an antistatic agent, an ultraviolet absorber, an infrared absorber, a colorant, an organic filler, an inorganic filler, organic fibers, inorganic fibers, and the like is usually blended in an amount in a range of 0.01% to 10% by weight, and more preferably blended in an amount in a range of 0.1% to 1% by weight, with respect to the total amount of the heat-shrinkable polyester film.

As shown in FIG. 6B, it is also preferable that other resin layers 10a and 10b including at least one of these various additives are laminated on one surface or both surfaces of the heat-shrinkable polyester film 10.

In that case, when the thickness of the heat-shrinkable polyester film is taken as 100%, it is preferable that the single layer thickness or the total thickness of the other resin layers that are additionally laminated has a value usually within a range of 0.1% to 10%.

The resin as a main component constituting the other resin layers may be the same polyester resin as that of the heat-shrinkable polyester film, or it is preferable that the resin is at least one of an acrylic resin, an olefin resin, a urethane resin, a rubber resin, and the like, which are different from the polyester resin.

### (8) Others 2

In addition, it is also preferable that the heat-shrinkable polyester film has a multilayer structure to further promote a hydrolysis preventing effect or mechanical protection, or as shown in FIG. 6C, a shrinkage ratio adjusting layer 10c is provided on the surface of the heat-shrinkable polyester film 10 so that the shrinkage ratio of the heat-shrinkable polyester film is uniform in the plane.

Such a shrinkage ratio adjusting layer can be laminated by using an adhesive, a coating method, a heating treatment, or the like depending on the shrinkage characteristics of the heat-shrinkable polyester film.

More specifically, the thickness of the shrinkage ratio adjusting layer is in a range of 0.1 to 3 μm, and when the shrinkage ratio of the heat-shrinkable polyester film at a predetermined temperature is excessively large, it is preferable to laminate a shrinkage ratio adjusting layer of a type that suppresses the large shrinkage ratio.

Furthermore, when the shrinkage ratio of the heat-shrinkable polyester film at a predetermined temperature is excessively small, it is preferable to laminate a shrinkage ratio adjusting layer of a type that increases the small shrinkage ratio.

Therefore, it is intended to obtain a desired shrinkage ratio by using a shrinkage ratio adjusting layer without producing various shrink films having different shrinkage ratios as the heat-shrinkable polyester film.

### Third Embodiment

A third embodiment is an embodiment related to a method for producing the heat-shrinkage polyester film of the second embodiment.

### 1. Raw Material Preparation and Mixing Step

First, it is preferable to prepare main agents and additives, such as a crystalline polyester resin, a non-crystalline polyester resin, a rubber resin, an antistatic agent, and a hydrolysis inhibitor, as raw materials.

Next, it is preferable that the prepared crystalline polyester resin, non-crystalline polyester resin, and the like are introduced into a stirring vessel while being weighed, and the raw materials are mixed and stirred using a stirring device until the mixture becomes uniform.

### 2. Original Sheet Production Step

Next, it is preferable that the uniformly mixed raw materials are dried into an absolutely dry state.

Next, typically, it is preferable to perform extrusion molding and produce an original sheet before stretching (sometimes simply referred to original sheet) having a predetermined thickness.

More specifically, for example, extrusion molding is performed by using an extruder (manufactured by TANABE PLASTICS MACHINERY CO., LTD.) with L/D 24 and an extrusion screw diameter of 50 mm under the conditions of an extrusion temperature of 245° C., and an original sheet having a predetermined thickness (usually, 30 to 1000 μm) can be obtained.

### 3. Production of Heat-Shrinkable Polyester Film

Next, the obtained original sheet is heated and pressed while being moved on rolls and between rolls by using a shrink film production apparatus to produce a heat-shrinkable polyester film.

That is, it is preferable that polyester molecules constituting the heat-shrinkable polyester film are crystallized into a predetermined shape by stretching the original sheet in a predetermined direction while heating and pressing the film while basically extending the film width at a predetermined preliminary heating temperature, stretching temperature, thermal fixation temperature, and the stretch ratio that will be described below.

Then, by solidifying the resultant in that state, a heat-shrinkable polyester shrink film that is used as decorations, labels, and the like can be produced.

### (1) Stretch Ratio in MD Direction

It is preferable that the stretch ratio in the MD direction (average MD direction stretch ratio, may be simply referred to as MD direction stretch ratio) of the heat-shrinkable polyester film before thermal shrinkage has a value within a range of 100% to 200%.

The reason for this is that by specifically limiting the MD direction stretch ratio to a value within a predetermined range, and specifically limiting each of the numerical values represented by thermal shrinkage ratios A1, A2, and A3, the value of the CIE chromaticity coordinates, the haze value, and the like to a value within a predetermined range, a heat-shrinkable polyester film that exhibits satisfactory recyclability can be obtained.

More specifically, it is because when the MD direction stretch ratio has a value of less than 100%, the product yield in production may be markedly decreased.

On the other hand, it is because when the MD direction stretch ratio is more than 200%, the shrinkage ratio in the TD direction is affected, and adjustment of the shrinkage ratio itself may be difficult.

Therefore, it is more preferable that the MD direction stretch ratio has a value within a range of 100% to 150%, and even more preferably a value within a range of 100% to 120%.

### (2) Stretch Ratio in TD Direction

Furthermore, it is a suitable embodiment that the stretch ratio in the TD direction (average TD direction stretch ratio, may be simply referred to as TD direction stretch ratio) of the heat-shrinkable polyester film before thermal shrinkage has a value within a range of 300% to 600%.

The reason for this is that by specifically limiting not only the above-mentioned MD direction stretch ratio but also the TD direction stretch ratio to values within predetermined ranges, and specifically limiting each of the numerical values represented by thermal shrinkage ratios A1, A2, and A3, the value of the CIE chromaticity coordinates, the haze value, and the like to a value within a predetermined range, a heat-shrinkable polyester film exhibiting enhanced recyclability, can be obtained.

More specifically, it is because when the TD direction stretch ratio has a value of less than 300%, the shrinkage ratio in the TD direction may be markedly decreased, and the use applications of the heat-shrinkable polyester film available for use may be excessively limited.

On the other hand, it is because when the TD direction stretch ratio has a value of more than 600%, the thermal shrinkage ratio may be markedly increased, and the use applications of the heat-shrinkable polyester film available for use may be excessively limited, or it may be difficult to control the stretch ratio itself to be constant.

Therefore, it is more preferable that the TD direction stretch ratio has a value within a range of 350% to 550%, and even more preferably a value within a range of 400% to 500%.

### 4. Heat-Shrinkable Polyester Film Inspection Step

It is preferable that the following characteristics and the like are measured continuously or intermittently for the produced heat-shrinkable polyester film, and a predetermined inspection step is provided.

That is, by measuring the following characteristics and the like by a predetermined inspection step and checking whether the values fall within predetermined ranges, a heat-shrinkable polyester film having more uniform shrinkage characteristics and the like can be obtained.
(1) Examination by visual inspection on the appearance of the heat-shrinkable polyester film
(2) Measurement of variation in thickness
(3) Measurement of tensile modulus of elasticity
(4) Measurement of tear strength
(5) Measurement of viscoelasticity characteristics using an SS curve

### Fourth Embodiment

A fourth embodiment is an embodiment related to a method of using the heat-shrinkable polyester film of the second embodiment.

Therefore, known methods of using shrink films can all be suitably applied.

For example, upon carrying out a method of using a heat-shrinkable polyester film, first, the heat-shrinkable polyester film is cut into an appropriate length or width, and at the same time, a long tubular-shaped object is formed.

Next, this long tubular-shaped object is supplied to an automatic label wrapping apparatus (shrink labeler) and further cut into a required length.

Next, the long tubular-shaped object is fitted onto a PET bottle filled with contents.

Next, as a heating treatment for the heat-shrinkable polyester film fitted onto a PET bottle or the like, the PET bottle or the like is passed through the inside of a hot air tunnel or a steam tunnel at a predetermined temperature.

Then, by blowing radiant heat such as infrared radiation or heated steam at about 90° C. provided in these tunnels from the surroundings, the heat-shrinkable polyester film is uniformly heated and thermally shrunk.

Therefore, a labeled container can be quickly obtained by closely attaching the heat-shrinkable polyester film to the outer surface of the PET bottle or the like.

Here, according to the heat-shrinkable polyester film of the present invention, as described above in the first embodiment, there is provided a heat-shrinkable polyester film derived from a polyester resin composition satisfying at least configurations (1) to (3).

In that way, even when the heat-shrinkable polyester film is left to stand for a long period of time under high humidity conditions, changes in physical properties associated with moisture absorption can be prevented, transparency and coloring property are maintained, and predetermined thermal shrinkage ratios can be obtained with satisfactory reproducibility at each heat treatment temperature.

Therefore, according to a heat-shrinkable polyester film derived from a predetermined polyester resin composition, recycling is made easy by satisfying the following configurations (1) to (3).

(1) The polyester resin composition contains a recycled PET resin as a portion or the entirety of a crystalline polyester resin in an amount of 10% by weight or more with respect to the total amount of the polyester resin composition.

(2) When the polyester resin composition is produced into a film having a predetermined thickness (for example, 30 μm), the haze value measured according to JIS K 7136:2000 is less than 20%.

(3) When the polyester resin composition is produced into a film having a predetermined thickness (for example, 30 μm), b* in the chromaticity coordinates of CIE 1976 L*a*b* as measured according to JIS Z 8781-4:2013 has a value within a range of 0.15 to 0.3.

### EXAMPLES

Hereinafter, the present invention will be described in detail on the basis of Examples. However, the scope of rights of the present invention is not to be limited by the description of Examples and the like, without any particular reason.

The polyester resins and the like used in the Examples and the like are as follows.

### (PETG1)

A non-crystalline polyester resin composed of dicarboxylic acid: 100 mol % of terephthalic acid, diol: 63 mol % of ethylene glycol, 13 mol % of diethylene glycol, and 24 mol % of 1, 4-cyclohexanedimethanol (PCR)

A recycled crystalline polyester resin composed of dicarboxylic acid: 98.6 mol % of terephthalic acid, 1.4 mol % of isophthalic acid, diol: 97.3 mol % of ethylene glycol, and 2.7 mol % of diethylene glycol

### (Additive (Anti-Blocking Agent))

A silica masterbatch composed of matrix resin: PET, silica content: 5% by mass, average particle size of silica: 2.7 μm

### Example 1

### 1. Evaluation of Polyester Resin Composition

### (1) Production of Heat-Shrinkable Polyester Film

On the occasion of evaluating the polyester resin composition, the resin composition was evaluated basically in the form of a heat-shrinkable polyester film.

That is, 90 parts by weight (pbw) of the non-crystalline polyester resin (PETG1), 10 parts by weight of the recycled crystalline polyester resin (PCR), and 1 part by weight of the predetermined additive (anti-blocking agent) were placed in a stirring vessel.

Next, these raw materials were brought into an absolutely dry state, subsequently extrusion molding was performed by using an extruder (manufactured by TANABE PLASTICS MACHINERY CO., LTD.) with L/D 24 and an extrusion screw diameter of 50 mm under the conditions of an extrusion temperature of 245° C., and an original sheet having a thickness of 150 μm was obtained.

Next, a heat-shrinkable polyester film having a thickness of 30 μm was produced from the original sheet by using a shrink film production apparatus at a preliminary heating temperature of 80° C., a stretching temperature of 80° C., a thermal fixation temperature of 75° C., and stretch ratios (MD direction: 100%, TD direction: 500%).

### 2. Evaluation of Heat-Shrinkable Polyester Film

### (1) Evaluation 1: Variation in Thickness

The thickness (taking the desired value of 30 μm as a reference value) of the obtained heat-shrinkable polyester film was measured by using a micrometer and was evaluated according to the following criteria. The obtained evaluation results are shown as Eva 1 in Table 1.
⊙(Very good): The variation in thickness is a value within a range of (reference value±0.1 μm).
◯(Good): The variation in thickness is a value within a range of (reference value±0.5 μm).
Δ(Fair): The variation in thickness is a value within a range of (reference value±1.0 μm).
X(Bad): The variation in thickness is a value within a range of (reference value±3.0 μm).

### (2) Evaluations 2 to 4: Thermal Shrinkage Ratios 1 to 3 (A1 to A3)

The thermal shrinkage ratios obtained when the obtained heat-shrinkable polyester film was left to stand for 24 hours under high humidity conditions of 20° C. and 90% RH and then thermally shrunk under the conditions of 10 seconds in hot water at 70° C., 80° C., and 98° C., respectively, were measured as thermal shrinkage ratios (A3, A1, and A2) in the TD direction. The obtained evaluation results are shown as Eva 2 to Eva 4 in Table 1.

(3) Evaluation 5: Haze value

For the obtained heat-shrinkable polyester film, the haze value was measured according to JIS K 7136:2000 by using a haze measuring apparatus (manufactured by Suga Test Instruments Co., Ltd., trade name: Haze Meter HZ-V3). The obtained evaluation results are shown as Eva 5 in Table 1.

### (4) Evaluations 6 to 9: CIE Chromaticity Coordinates

For the obtained heat-shrinkable polyester film, a*, b*, a numerical value represented by b*-b*₀, and L* in the chromaticity coordinates in the CIE1976 L*a*b* as measured according to JIS Z 8781-4:2013 were each measured by using a spectrophotometer (manufactured by SHIMADZU CORPORATION, product name “UV-3600”). The obtained evaluation results are shown as Eva 6 to Eva 9 in Table 1.

For an original sheet (thickness 150 μm) before stretching of the obtained heat-shrinkable polyester film, L*, a*, and b* in the CIE chromaticity coordinates were measured according to JIS Z 8781-4:2013, and it was verified that values almost equal to those of the obtained heat-shrinkable polyester film are obtained.

For reference, for the non-crystalline polyester resin (PETG1) in a pellet state, which was a raw material of the heat-shrinkable polyester film, L*, at, and b* in the CIE chromaticity coordinates were measured, and the values were 63.77, −1.76, and 0.00, respectively.

Similarly, for the recycled crystalline polyester resin (PCR) in a pellet state, L*, at, and b* in the CIE chromaticity coordinates were measured, and the values were 60.97, −1.10, and 4.19.

### Example 2

In Example 2, as shown in Table 1, 70 parts by weight of the non-crystalline polyester resin (PETG1), 30 parts by weight of the recycled crystalline polyester resin (PCR), and 1 part by weight of the predetermined additive (anti-blocking agent) were used.

At the same time, a heat-shrinkable polyester film having a thickness of 30 μm was produced in the same manner as in Example 1, from an original sheet at a preliminary heating temperature of 80° C., a stretching temperature of 80° C., a thermal fixation temperature of 75° C., and stretch ratios (MD direction: 100%, TD direction: 500%).

For the produced heat-shrinkable polyester film, the CIE chromaticity coordinates and the like were evaluated in the same manner as in Example 1. The obtained evaluation results are shown in Table 1.

### Example 3

In Example 3, as shown in Table 1, 50 parts by weight of the non-crystalline polyester resin (PETG1), 50 parts by weight of the recycled crystalline polyester resin (PCR), and 1 part by weight of the predetermined additive (anti-blocking agent) were used.

At the same time, a heat-shrinkable polyester film having a thickness of 30 μm was produced in the same manner as in Example 1, from an original sheet at a preliminary heating temperature of 80° C., a stretching temperature of 80° C., a thermal fixation temperature of 75° C., and stretch ratios (MD direction: 100%, TD direction: 500%).

For the produced heat-shrinkable polyester film, the CIE chromaticity coordinates and the like were evaluated in the same manner as in Example 1. The obtained evaluation results are shown in Table 1.

### Comparative Example 1

In Comparative Example 1, a heat-shrinkable polyester film was produced in the blending composition shown in Table 1, and the heat-shrinkable polyester film was evaluated in the same manner as in Example 1.

That is, 100 parts by weight of the non-crystalline polyester resin (PETG1) and 1 part by weight of the predetermined additive (anti-blocking agent) were used.

At the same time, a heat-shrinkable polyester film having a thickness of 30 μm was produced from an original sheet at a preliminary heating temperature of 80° C., a stretching temperature of 80° C., a thermal fixation temperature of 75° C., and stretch ratios (MD direction: 100%, TD direction: 500%).

For the produced heat-shrinkable polyester film, the CIE chromaticity coordinates and the like were evaluated in the same manner as in Example 1. The obtained evaluation results are shown in Table 1.

### Comparative Example 2

In Comparative Example 2, a heat-shrinkable polyester film was produced in the blending composition shown in Table 1, and the heat-shrinkable polyester film was evaluated in the same manner as in Example 1.

That is, 30 parts by weight of the non-crystalline polyester resin (PETG1), 70 parts by weight of the recycled crystalline polyester resin (PCR), and 1 part by weight of the predetermined additive (anti-blocking agent) were used.

At the same time, a heat-shrinkable polyester film having a thickness of 30 μm was produced from an original sheet at a preliminary heating temperature of 80° C., a stretching temperature of 80° C., a thermal fixation temperature of 75° C., and stretch ratios (MD direction: 100%, TD direction: 500%).

For the produced heat-shrinkable polyester film, the CIE chromaticity coordinates and the like were evaluated in the same manner as in Example 1. The obtained evaluation results are shown in Table 1.

### Comparative Example 3

In Comparative Example 3, a heat-shrinkable polyester film was produced in the blending composition shown in Table 1, and the heat-shrinkable polyester film was evaluated in the same manner as in Example 1.

That is, 100 parts by weight of the recycled crystalline polyester resin (PCR) and 1 part by weight of the predetermined additive (anti-blocking agent) were used.

At the same time, a heat-shrinkable polyester film having a thickness of 30 μm was produced from an original sheet at a preliminary heating temperature of 80° C., a stretching temperature of 80° C., a thermal fixation temperature of 75° C., and stretch ratios (MD direction: 100%, TD direction: 500%).

For the produced heat-shrinkable polyester film, the CIE chromaticity coordinates and the like were evaluated in the same manner as in Example 1. The obtained evaluation results are shown in Table 1.

TABLE 1

| | Configuration | | | | | | | | | | | |
|---|---|---|---|---|---|---|---|---|---|---|---|---|
| | PETG1 | PCR | Additive | | | | | | | | | |
| | (pbw) | (pbw) | (pbw) | Eva 1 | Eva 2 | Eva 3 | Eva 4 | Eva 5 | Eva 6 | Eva 7 | Eva 8 | Eva 9 |
| Example 1 | 90 | 10 | 1 | ⊙ | 16 | 49 | 70 | 1.64 | −0.10 | 0.15 | 0.03 | 97.79 |
| Example 2 | 70 | 30 | 1 | ⊙ | 9 | 37 | 52 | 1.82 | −0.07 | 0.22 | 0.10 | 97.77 |
| Example 3 | 50 | 50 | 1 | ⊙ | 6 | 29 | 36 | 1.59 | −0.13 | 0.26 | 0.14 | 97.80 |
| Comparative | 100 | 0 | 1 | ⊙ | 30 | 58.5 | 77 | 1.87 | −0.09 | 0.12 | 0.00 | 97.75 |
| Example 1 | | | | | | | | | | | | |
| Comparative | 30 | 70 | 1 | ⊙ | 2 | 18 | 24 | 1.70 | −0.14 | 0.33 | 0.21 | 97.70 |
| Example 2 | | | | | | | | | | | | |
| Comparative | 0 | 100 | 1 | ⊙ | 1 | 8 | 14 | 1.77 | −0.16 | 0.39 | 0.27 | 97.71 |
| Example 3 | | | | | | | | | | | | |

*Eva 1: Variation in thickness
*Eva 2 to 4: Thermal shrinkage ratios 1 to 3 (A1 to A3)
*Eva 5: Haze value
*Eva 6: a* value
*Eva 7: b* value
*Eva 8: b* − b*₀ value
*Eva 9: L* value

### INDUSTRIAL APPLICABILITY

According to the present invention, a predetermined polyester resin composition that maintains excellent transparency and non-coloring property even when repeatedly recycled, and a heat-shrinkable polyester film derived from the polyester resin composition can be obtained by satisfying at least configurations (1) to (3).

More specifically, a predetermined polyester resin composition that maintains excellent transparency and non-coloring property even when repeatedly recycled at least 10 or more times, and a heat-shrinkable polyester film derived from the polyester resin composition can be obtained.

According to the polyester resin composition of the present invention, various molded articles including a heat-shrinkable polyester film can be obtained.

For example, a PET bottle having excellent transparency and non-coloring property can be molded by using the polyester resin composition of the present invention.

Therefore, even in a case where a molded PET bottle is recycled, satisfactory transparency and non-coloring property can be maintained.

With regard to such PET bottles, in a case where the heat-shrinkable polyester film of the present invention is used, there is an advantage that when the PET bottles are recycled, the PET bottles can be recycled without separating and removing the heat-shrinkable polyester film in advance.

Therefore, according to the predetermined polyester resin composition of the present invention and a heat-shrinkable polyester film derived from the polyester resin composition, since versatility and environmental characteristics can be remarkably enhanced by suitably applying the polyester resin composition and the heat-shrinkable polyester film to various PET bottles, heat-shrinkable labels for various PET bottles, outer covering materials for lunch boxes and the like, it can be said that industrial applicability thereof is very high.

The invention claimed is:

1. A polyester resin composition comprising at least a recycled PET resin,
the polyester resin composition satisfying the following configurations (1) to (3):
(1) a blending amount of the recycled PET resin as a portion or entirety of a crystalline polyester resin has a value of 10% by weight or more with respect to a total amount of the polyester resin composition;
(2) when the polyester resin composition is produced into a film having a predetermined thickness, a haze value measured according to JIS K 7136:2000 is less than 20%; and
(3) when the polyester resin composition is produced into a film having a predetermined thickness, b* in chromaticity coordinates of CIE1976 L*a*b* as measured according to JIS Z 8781-4:2013 has a value within a range of 0.15 to 0.3.

2. The polyester resin composition according to claim 1, wherein as configuration (4), when a recycled PET resin is not blended, and the polyester resin composition is produced into a film having a predetermined thickness, in a case where b* in the chromaticity coordinates of the CIE1976 L*a*b* as measured according to JIS Z 8781-4:2013 is designated as b*₀, a numerical value represented by b*-b*₀, has a value of 0.01 or more.

3. The polyester resin composition according to claim 1, wherein as configuration (5), when the polyester resin composition is produced into a film having a predetermined thickness, a* in the chromaticity coordinates of CIE1976 L*a*b* as measured according to JIS Z 8781-4:2013 has a value within a range of −0.15 to −0.05.

4. The polyester resin composition according to claim 1, wherein as configuration (6), when the polyester resin composition is produced into a film having a predetermined thickness, L* in the chromaticity coordinates of CIE 1976 L*a*b* as measured according to JIS Z 8781-4:2013 has a value of 90 or more.

5. The polyester resin composition according to claim 1, wherein as configuration (7), the polyester resin composition includes a non-crystalline polyester resin, and a blending amount of the non-crystalline polyester resin has a value within a range of 50% to 90% by weight with respect to the total amount of the polyester resin composition.

6. A heat-shrinkable polyester film derived from the polyester resin composition according to claim 1,
wherein when a main shrinkage direction of the heat-shrinkable polyester film is designated as TD direction, and a thermal shrinkage ratio obtained in a case where the heat-shrinkable polyester film is shrunk in the TD direction under the conditions of 10 seconds in hot water at 80° C. is designated as A1, the A1 has a value of 20% or more.

7. The heat-shrinkable polyester film according to claim 6, wherein when a thermal shrinkage ratio obtained in a case where the heat-shrinkable polyester film is shrunk in the TD direction under the conditions of 10 seconds in hot water at 98° C. is designated as A2, the A2 has a value of 35% or more.

8. The heat-shrinkable polyester film according to claim 6, wherein when a thermal shrinkage ratio obtained in a case where the heat-shrinkable polyester film is shrunk in the TD direction under the conditions of 10 seconds in hot water at 70° C. is designated as A3, the A3 has a value of 5% or more.
